(19) United States
(12) Patent Application Publication
(10) Pub. No.: US 2006/0271613 A1
(43) Pub. Date: Nov. 30, 2006

(54) Apparatus and method for performing FFT operation

(75) Inventors: Syunji Mitsuishi, Hino (JP); Hideaki Yokoyama, Hino (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/213,513

(22) Filed: Aug. 26, 2005

(30) Foreign Application Priority Data
May 27, 2005 (JP) 2005-155608

(51) Int. Cl. G06F 17/14

(52) U.S. Cl. 708/404

(57) ABSTRACT

An FFT operation apparatus performs the real number FFT operation in real time for an extremely large number of data using a cache memory. The cache memory stores a part of data to be operated through the real number FFT. An FFT operation unit performs the real number FFT operation for the data stored in the cache memory. The FFT operation unit performs the data transfer between the cache memory and the external memory at least once after any of the stages in the first butterfly operation of multiple stages to read data to be required in subsequent butterfly operation in the first butterfly operation and the second butterfly operation for acquiring the transform results into the cache memory, performs the subsequent butterfly operation using the read data, and performs the second butterfly operation directly using the data stored in the cache memory after the first butterfly operation.

### CROSS-REFERENCE TO RELATED APPLICATIONS

This application claims the conventional priority based on Japanese Application No. 2005-155608, filed on May 27, 2005, the disclosures of which are incorporated herein by reference.

### BACKGROUND OF THE INVENTION

1. Field of the Invention

This invention generally relates to an apparatus and method for performing FFT operation, and more particularly to an apparatus and method for performing the FFT operation in real time for a great number of data using a cache memory.

2. Description of the Related Art

The speed-up of FFT (Fast Fourier Transform) operation depends on how the data transfer is made efficiently between a high-speed cache memory of small size and a low-speed external memory of large size in most cases.

For example, it has been proposed that the data to be operated is partitioned into segments of a prescribed size corresponding to the size of a cache memory concerned, and relocated so that the data referred to by the operation in each segment may be located sequentially, whereby the data of each segment to be relocated is arithmetically operated in each segment (refer to Japanese Patent Laid-Open No. 2002-049612).

Also, it has been proposed that for the FFT operation that processes at high speed the data of large size by making effective use of a high-speed internal memory, the FFT data is decomposed into a plurality of blocks conforming with a small size high-speed memory, the data is transferred for every block between the high-speed memory and an external memory, and the FFT operation of the FFT data accumulated in the high-speed memory is performed (refer to Japanese Patent Laid-Open No. 2002-169792).

In an electric wave interferometer useful in the space exploration, the outputs of a plurality of radio telescopes are processed in real time by performing the FFT operation and then the cross correlation operation between each antenna output is performed. To improve the observation precision, for example, the signals (GHz band) including a right and left polarized radiation from each of 16 antennas are divided into four for every appropriate band, and each signal processed by 8 amplifiers and analog-to-digital converters is subjected to the FFT operation. In this case, it is necessary to finish the FFT operations for up to 1M(mega) points in several ms. (milliseconds).

The FFT operation in real time of such an extremely large amount of data was not conventionally performed. To perform the FFT operation of such extremely large amount of data in real time, it is conceived to employ the super computer that has quite fast operation speed and can employ unlimited size of the cache memory. However, the development cost and the development period become enormous, and are not realistic.

### SUMMARY OF THE INVENTION

We examined that the FFT operations for up to 1M points are performed in real time, employing one or more arithmetic units (for example, DSP: Digital Signal Processor) having an operation frequency of several GHz, commercially available on the market. And, we found that noting that the output of the electric wave interferometer is the real number in the FFT operation, the FFT operations for up to 1M points can be performed in real time. This invention is based on such a new finding.

An object of the present invention is to provide an FFT operation apparatus that performs in real time the real number FFT operation for an extremely large number of data using a cache memory.

Another object of the present invention is to provide an FFT operation method for performing the real number FFT operation in real time for an extremely large number of data using a cache memory.

An FFT operation apparatus of the present invention includes an external memory for storing data to be subjected to the real number FFT operation, a cache memory for storing a part of the data to be subjected to the real number FFT operation by performing the data transfer with the external memory, the size of the cache memory being smaller than the size of the data to be subjected to the real number FFT operation, and an FFT operation unit for performing the real number FFT operation for the data stored in the cache memory, the real number FFT operation comprising first butterfly operation of multiple stages and second butterfly operation for acquiring the transform results. The FFT operation unit performs the data transfer between the cache memory and the external memory at least once after any of the stages in the first butterfly operation of multiple stages to read data to be required in subsequent butterfly operation in the first butterfly operation of multiple stages and the second butterfly operation for acquiring the transform results into the cache memory, performs the subsequent butterfly operation in the first butterfly operation of multiple stages using the read data, and performs the second butterfly operation for acquiring the transform results directly using the data stored in the cache memory after the first butterfly operation of multiple stages.

An FFT operation apparatus of the present invention includes an external memory for storing data to be subjected to the real number FFT operation, a cache memory for storing a part of the data to be subjected to the real number FFT operation by performing the data transfer with the external memory, the size of the cache memory being smaller than the size of the data to be subjected to the real number FFT operation, and an FFT operation unit for performing the real number FFT operation for the data stored in the cache memory, the real number FFT operation comprising first butterfly operation of multiple stages and second butterfly operation for acquiring the transform results. The FFT operation unit performs the data transfer between the cache memory and the external memory only once per size of the cache memory after any of the stages in the first butterfly operation of multiple stages to reads data to be required in subsequent butterfly operation in the first butterfly operation of multiple stages and the second butterfly operation for acquiring the transform results into the cache memory, and performs the subsequent butterfly operation in the first butterfly operation of multiple stages and the second butterfly operation for acquiring the transform results directly using the data stored in the cache memory.

Preferably, in the FFT operation apparatus of the present invention, the FFT operation unit performs the butterfly operation after the data transfer by dividing the butterfly operation into the butterfly operation toward the ascending order of data to be subjected to the real number FFT operation and the butterfly operation toward the descending order of data to be subjected to the real number FFT operation.

An FFT operation method of the present invention performs the real number FFT operation for the data stored in a cache memory. The operation includes first butterfly operation of multiple stages and second butterfly operation for acquiring the transform results, and uses an external memory for storing data to be subjected to the real number FFT operation and the cache memory for storing a part of the data to be subjected to the real number FFT operation by performing the data transfer with the external memory. The size of the cache memory is smaller than the size of the data to be subjected to the real number FFT operation. The method includes performing the data transfer between the cache memory and the external memory at least once after any of the stages in the first butterfly operation of multiple stages to read data to be required in subsequent butterfly operation in the first butterfly operation of multiple stages and the second butterfly operation for acquiring the transform results into the cache memory, performing the subsequent butterfly operation in the first butterfly operation of multiple stages using the read data, and performing the second butterfly operation for acquiring the transform results directly using the data stored in the cache memory after the first butterfly operation of multiple stages.

An FFT operation method of the present invention performs the real number FFT operation for the data stored in a cache memory. The operation includes a butterfly operation of multiple stages and a butterfly operation for acquiring the transform results, and uses an external memory for storing data to be subjected to the real number FFT operation and the cache memory for storing a part of the data to be subjected to the real number FFT operation by performing the data transfer with the external memory. The size of the cache memory is smaller than the size of the data to be subjected to the real number FFT operation. The method includes changing sequence of data on the cache memory halfway of the first butterfly operation of multiple stages to make unnecessary the data transfer between the cache memory and the external memory in the middle of the first butterfly operation of multiple stages and the second butterfly operation for acquiring the transform results.

In the FFT operation apparatus and method of the present invention, noting that the data to be operated is the real value, the number of making the FFT operation is reduced. Additionally, in the present invention, the number of making the data transfer between the cache memory and the external memory (main memory) is reduced using the characteristics of the real number FFT operation.

More specifically, in the present invention, noting that only the real part obtained by square detection is meaningful in the electric wave interferometer, the FFT operation of a real value function (hereinafter simply referred to as real number FFT) is performed using the imaginary part of a complex value time function. Thereby, the number of making the real number FFT operation can be made half the number of making the FFT operation with the complex value time function (normal FFT operation). Moreover, in the present invention, noting not the normal FFT operation but the real number FFT operation is performed, the rearrangement (shuffling) of data in view of the characteristics of the real number FFT operation is performed. Thereby, it is unnecessary to perform the data transfer immediately before the operation for restoring the transform results from the result of the simultaneous FFT operation. As described above, according to the present invention, the time of FFT operation itself is shortened, and the time of data transfer is shortened, whereby the FFT operation for an extremely large amount of data such as 1M points can be performed in real time.

Preferably, in the FFT operation apparatus of the present invention, the butterfly operation after the data transfer is performed by dividing the butterfly operation into the butterfly operation toward the ascending order of data to be subjected to the real number FFT operation and the butterfly operation toward the descending order of data. Thereby, in the FFT operation for a large amount of data, it is unnecessary to perform the data transfer between the butterfly operation of multiple stages and the butterfly operation for acquiring the transform results, whereby the time of data transfer is shortened, contributing to the FFT operation in real time.

### BRIEF DESCRIPTION OF THE DRAWINGS

FIG. 1A is a diagram showing one example of a structure of an FFT operation apparatus according to the present invention, and FIG. 1B is a diagram showing one example of storage areas of a cache memory.

FIG. 2 is an explanatory diagram of the FFT operation according to the present invention.

FIG. 3 is an explanatory diagram of the FFT operation according to the present invention.

FIG. 4 is an explanatory diagram of the FFT operation according to the present invention.

FIG. 5A and FIG. 5B are explanatory diagrams of the FFT operation according to the present invention.

FIG. 6 is another explanatory diagram of the FFT operation according to the present invention.

FIG. 7 is another explanatory diagram of the FFT operation according to the present invention.

### DETAILED DESCRIPTION OF THE PREFERRED EMBODIMENTS

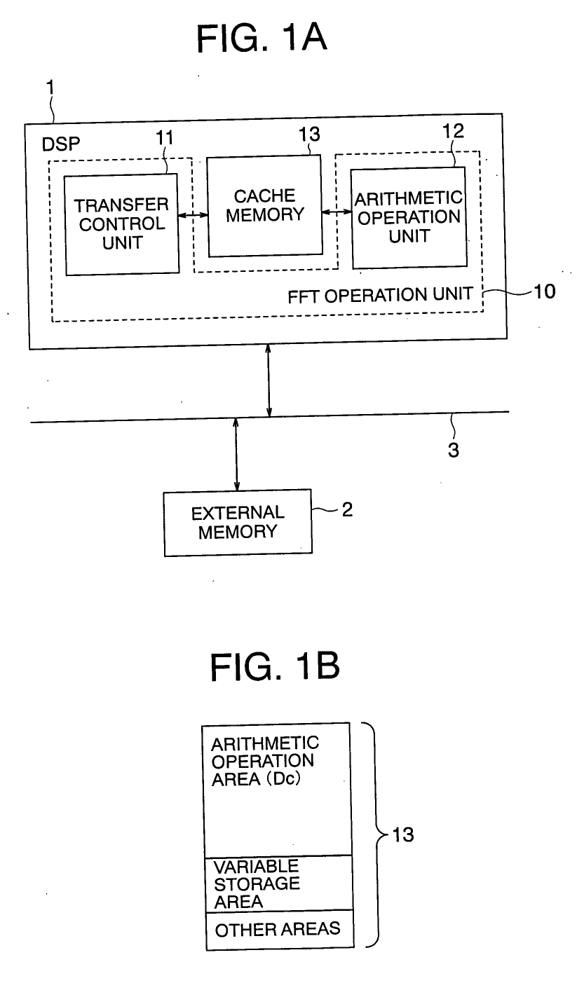

FIG. 1A is a block diagram showing one example of a structure of an FFT operation apparatus according to the present invention. This FFT operation apparatus comprises a DSP 1 that is an operation apparatus, an external memory 2, and a system bus 3 connecting them. The DSP 1 comprises a cache memory 13 and an FFT operation unit 10. In this embodiment, the FFT operation unit 10 comprises a transfer control unit 11 and an arithmetic operation unit 12, and performs the real number FFT operation.

The external memory 2 is a main memory that comprises a DRAM (Dynamic Random Access Memory), for example, and storing the data to be subjected to the real number FFT operation. Though being not shown in the figure, this data is a signal acquired by dividing the signals (GHz band) including a right and left polarized radiation from each of 16 antennas in an electric wave interferometer into four for every appropriate band, and processing each signal by the 8 amplifiers and AD (Analog to Digital) converters. This data is the signal corresponding to the FFT operations of 1M points, and it is necessary to process the data in several milliseconds.

The cache memory 13 stores a part of data to be subjected to the real number FFT operation by making the data transfer via the system bus 3 with the external memory 2. The cache memory 13 is a high-speed memory (primary cache) that comprises an SRAM (Static Random Access Memory) provided within a chip of the DSP 1, for example, and much faster than the external memory 2, as well known. The size of the cache memory 13 is smaller than that of the data to be subjected to the real number FFT operation. The cache memory 13 may be a memory (secondary cache) mounted on the same mounting board (printed circuit board) as the DSP 1, or may be mounted on the different mounting board from the DSP 1, as far as it is much faster than the external memory 2.

In this specification, the “size of the cache memory 13” means the storage area Dc used for the FFT operation in all of the storage areas (capacity) as shown in FIG. 1B. In the cache memory 13, not all of the storage areas are used for the FFT operation. The cache memory 13 is provided with a variable storage area and other areas. The variable storage area stores various variables and supplementary variables required for the FFT operation and other operations as will be described later.

The FFT operation unit 10 controls the data transfer between the cache memory 13 and the external memory 2 by the transfer control unit 11, and performs the real number FFT operation for the data stored in the cache memory 13 by the arithmetic operation unit 12. The transfer control unit 11 is composed of a DMA (Direct Memory Access controller), as well known.

The FFT operation unit 10 reads the data to be operated from the external memory 2 to the cache memory 13 via the system bus 3 by the transfer control unit 11, and performs the butterfly operation of multiple stages for the real number FFT operation by the arithmetic operation unit 12. The FFT operation unit 10 backups or writes (memory write: MW) and reads (memory read: MR) the data stored in the cache memory 13 by the data transfer between the cache memory 13, and the external memory 2 via the system bus 3 after any stage of the butterfly operation, by the transfer control unit 11. Thereby, the sequence of the data is changed.

Thereafter, the FFT operation unit 10 performs the remaining butterfly operation, using the data in the changed sequence, by dividing it two parts, the first being in the forward direction and the second being in the reverse direction of the address, by the arithmetic operation unit 12. And, after the butterfly operation of multiple stages, the FFT operation unit 10 performs the operation of restoring the data in the real part and the imaginary part to be paired for the real number FFT operation, directly using the data stored in the cache memory 13, by the arithmetic operation unit 12. Thereafter, the FFT operation unit 10 writes the restored data from the cache memory 13 into the external memory 2 via the system bus 3, by the transfer control unit 11.

The amount of input data (number of FFT points) in the external memory 2 is larger than the size of the cache memory 13, as previously described. Accordingly, the DSP 1 (FFT operation unit 10) actually performs the FFT operation for the data in time division. That is, the data to be operated is decomposed into blocks with the size of the cache memory 13 as a unit, and the above-mentioned process is performed for each block, as well known. In place of this, a plurality of DSPs 1 (FFT operation units 10) may be provided to perform the FFT operations in parallel.

Next, as the premise for a specific explanation of the present invention, the FFT operation performed by the FFT operation unit 10 in its arithmetic operation unit 12, or the discrete Fourier transform (FFT) operation of a real value function x(k) represented by 2N samples using the imaginary part of a complex value time function, will be simply described below. This is the FFT operation involving the so-called 2N-sample transform by transforming N samples (2N-point transformation by transforming N points), as well known, but simply called the “real number FFT operation” in this specification. The real number FFT operation comprises the following operation steps a to e.

Operation step a: firstly, define the function x(k) as a real value function (k=0, 1, . . . , 2N−1).

Operation step b: decompose the function x(k) into two functions h(k) and g(k). Where
h(k)=x(2k)
g(k)=x(2k+1)
(k=0, 1, . . . , N−1). Thereby, the function x(k) is decomposed into function h(k) of even-numbered samples and function g(k) of odd-numbered samples.

Operation step c: generate the complex value function y(k) (k=0, 1, . . . , N−1).
y(k)=h(k)+jg(k)
Where h(k) and g(k) are the real part and the imaginary part of y(k), respectively. Thereby, the imaginary part of the complex value function can be utilized.

Operation step d: compute Y(n)=R(n)+jI(n) (n=0, 1, . . . , N−1) according to the Formula (1) below.

$$\begin{matrix}Y ( n ) = {\sum }_{k = 1}^{N - 1} y ( k ) {ⅇ}^{a} \\ wherein , \\ a = - j 2 π nk / N\end{matrix} \} \qquad Formula ( 1 )$$

Where R(n) and I(n) are the real part and the imaginary part of Y(n), respectively. In this specification, the operation steps b, c and d are referred to as the “butterfly operation of multiple stages”.

Operation step e: compute Xr(n) and Xi(n) (n=0, 1, . . . , N−1) according to the Formula (2) below. Where N is the number of points (number of data) for the FFT operation, and n is the position of the data.

$$\begin{matrix}\begin{matrix}Xr ( n ) = [ R ( n ) / 2 + R ( N - n ) / 2 ] + \\ cos π n / N [ I ( n ) / 2 + I ( N - n ) / 2 ] - \\ sin π n / N [ R ( n ) / 2 - R ( N - n ) / 2 ]\end{matrix} \\ \begin{matrix}Xi ( n ) = [ I ( n ) / 2 - I ( N - n ) / 2 ] - \\ sin π n / N [ I ( n ) / 2 + I ( N - n ) / 2 ] - \\ cos π n / N [ R ( n ) / 2 - R ( N - n ) / 2 ]\end{matrix}\end{matrix} \} \qquad Formula ( 2 )$$

Where Xr(n) and Xi(n) are the real part and the imaginary part of 2N-point discrete transform for x(k), respectively. Thereby, the transform results can be acquired from the result of the simultaneous FFT operation using the imaginary part of the complex value function. In this specification, the operation step e is referred to as the “butterfly operation for acquiring the transform results”.

The above operation steps a to e are applied to the present invention in the following way. In this example, since the data acquired by square detection using the electric wave interferometer is operated, the function x(k) can be considered as the real value function. Accordingly, the operation step a may be ignored in this example (obtained data may be employed). The operation steps b and c may be performed through the well-known process.

On the contrary, the operation steps d and e may be performed through the well-known process, namely, the process using the butterfly operation. And, according to the present invention, the location of the data to be operated within the cache memory 13 is changed by making the data transfer between the cache memory 13 and the external memory 2 at least once. Thereby, the data transfer between the cache memory 13 and the external memory 2 for the operation steps d and e becomes unnecessary. Moreover, the data transfer between the cache memory 13 and the external memory 2 at the operation step d is actually required minimum number of times, irrespective of the FFT operations of 1M points. This number of times is only one, as will be described later. That is, the data transfer is performed only once to make unnecessary the data transfer for the operation steps d and e.

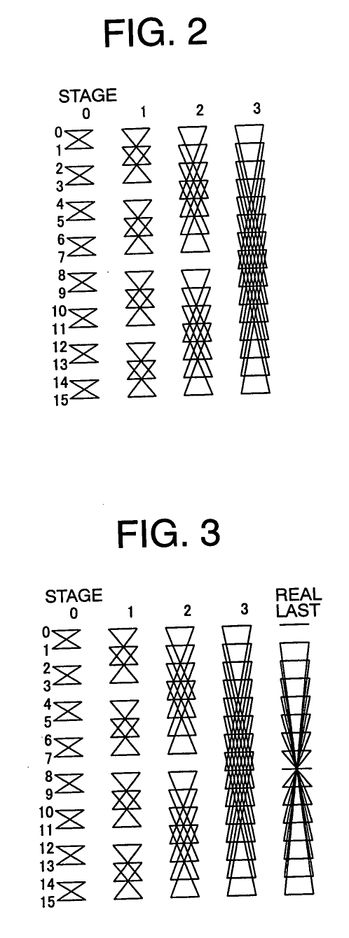

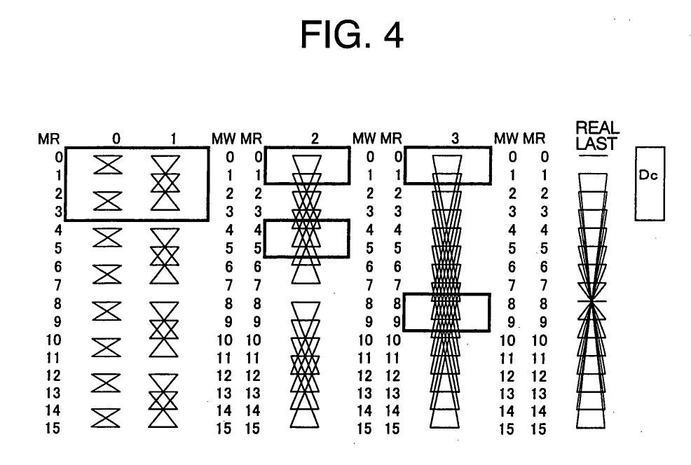

Referring to FIGS. 2 to 5B, the FFT operation of the present invention will be specifically described. The FFT operation (16 bits/point) of 1M points (2 to the power 20) is performed in the present invention, but for the simpler explanation, the FFT operation of 16 (2 to the power 4) points is exemplified in the following. The FFT operation of 16 points ((real part 16 bits+imaginary part 16 bits)×16) corresponds to the FFT operation of 32 points (real part 16 bits×32) in the real number FFT operation. Here, it is supposed that the size of the cache memory 13 (size of operation area Dc) provided for the DSP 1 is capable of storing 4 data (32 bits/point) (size of 4 data) at a time (see FIG. 4).

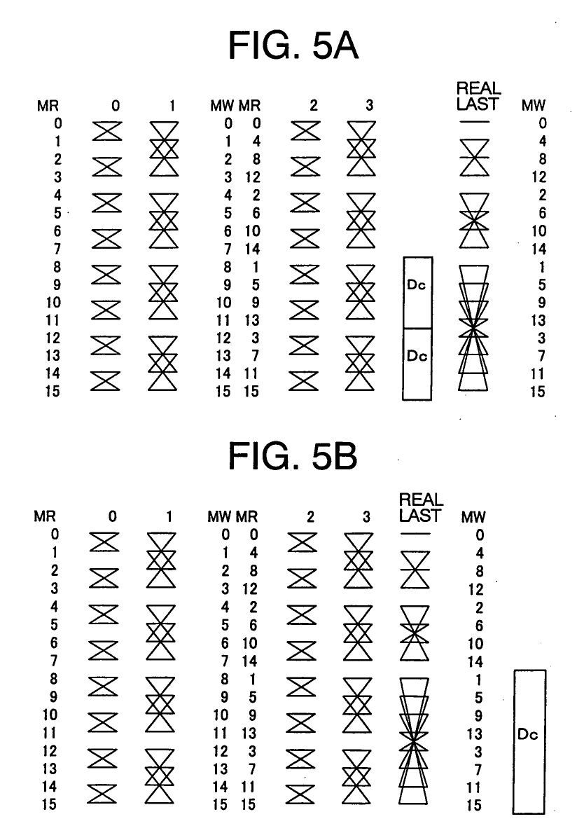

FIG. 2 shows a basic method for performing the FFT operation, FIG. 3 shows a basic method for performing the real number FFT operation, and FIG. 4 shows the real number FFT operation with the write/read of the data in FIG. 3. FIG. 5A and FIG. 5B show an example in which the real number FFT operation of FIG. 4 is changed according to the present invention. In FIGS. 2 to 5B, the number in the longitudinal direction indicates the memory address of the data, and the number in the transverse direction indicates the operation stage. The memory address is decided conforming or according to the position of the data, as well known.

As shown in FIG. 2, the (normal) FFT operation of 16 points using the real part and the imaginary part of the complex value time function is performed by the butterfly operation of four stages from the zeroth stage to the third stage. That is, each of a pair of upper and lower triangles as shown in FIG. 2 simply represents the butterfly operation in the flow of signal (signal flow) of the FFT operation (same below). In FIG. 2, for the simpler explanation, the write/read of data into/from the external memory 2 is not considered (same in FIG. 3), and the size of the cache memory 13 is not considered.

On the other hand, the real number FFT operation needs the butterfly operation from the zeroth stage to the third stage, and the operation for acquiring two transform results from each of the results of the simultaneous FFT operation performed thereafter (hereinafter referred to a real LAST stage), as shown in FIG. 3. That is, the butterfly operation (operation steps b to d) of multiple stages and the subsequent butterfly operation (operation step e, namely, real LAST stage) for acquiring the transform results are needed for the real number FFT operation. From FIG. 3, it will be found that at the real LAST stage, the paired data to be operated are shifted and differently combined, as compared with at four stages from the zeroth stage to the third stage, as well known. This will be also apparent from above-mentioned Formula (2).

When the write/read of data into/from the external memory 2 is considered in FIG. 3, FIG. 4 results. In FIG. 4, the data transfer (backup) from the cache memory 13 to the external memory 2 is represented as the memory write MW, and the data transfer (read) from the external memory 2 to the cache memory 13 is represented as the memory read MR (same below). The combination of MW and MR is referred to as the data transfer between the cache memory 13 and the external memory 2. FIG. 4 corresponds to an example of the conventional real number FFT operation.

Herein, considering that the size of the cache memory 13 is the amount of four data, two kinds of data transfer may occur as follows. In FIG. 4, the size of the cache memory 13, or the size of the operation area Dc, is shown along with the data of the FFT operation.

The first data transfer is the data transfer specific to the real number FFT operation. That is, since the paired data to be operated are shifted, and differently combined, as previously described, the data transfer between the cache memory 13 and the external memory 2 is required for almost all the data to make the rearrangement (shuffling) of data between the third stage and the real LAST stage. Accordingly, in the FFT operation of 1M points, for example, the time for this data transfer has a great influence on the operation time. The reason why the rearrangement of all the data is needed is that only the combination of data in the butterfly operation of multiple stages (chiefly operation step d) for the real number FFT operation is conventionally made aware of.

The second data transfer is the data transfer not only occurring in the real number FFT operation, but normally occurring in the FFT operation. That is, the DSP 1 expands four data including the zeroth data to the third data on the cache memory 13 by once reading from the external memory 2. These four data are not backed up into the external memory 2 but subjected to the butterfly operation at two stages of the zeroth stage and the first stage, as indicated surrounded by the thick line.

However, at the second stage and beyond, it is required to backup and read the data into and from the external memory 2 frequently (at every stage). That is, in the operation at the second stage, the zeroth, first, fourth and fifth data are pairs of the butterfly operation, as indicated surrounded by the thick line. In the operation at the third stage, the zeroth, first, eighth and ninth data are pairs of the butterfly operation, as indicated surrounded by the thick line. Accordingly, the rearrangement of data using the data transfer is needed between the first stage and the second stage, and between the second stage and the third stage.

When the size Dc of the cache memory 13 is the amount of eight data, for example, the data transfer between the first stage and the second stage is unnecessary, but the data transfer at the subsequent stages is still required. The number of data transfer depends on the size Dc of the cache memory 13.

Moreover, the third data transfer actually occurs. Since the number of data to be subjected to the FFT operation is 16, it is required to perform the FFT operation four times. That is, after the end of the zeroth and first stages for the zeroth to third data, the data transfer is performed, and the zeroth and first stages for the fourth to seventh data are performed. Thereafter, the data transfer, the zeroth and first stages for the eighth to eleventh data, the data transfer, and the zeroth and first stages for the twelfth to fifteenth data are performed. Moreover, the second and third stages are similarly performed while the data transfer is repeated. The third data transfer can not be omitted, not to say the number of making the data transfer.

In this manner, in FIG. 4 (prior art), access to the external memory 2 occurs at every stage since a certain stage. Therefore the processing time greatly increases. Also, access to the external memory 2 occurs at the address that was aware of the stage of characteristics in the FFT operation, and because the address is not successive in a case the external memory 2 is DRAM, the burst transfer is ineffective, causing the operation time to be increased.

In the present invention, the above-mentioned first data transfer is omitted. Therefore, the combination of data in the butterfly operation (real LAST stage) for acquiring the transform results is given preference in the present invention. That is, in FIG. 5A and FIG. 5B, the zeroth and eighth data are not paired at the real LAST stage, and the fourth data and the twelfth data are subjected to the butterfly operation. At the third stage, the zeroth data and the eighth data, and the fourth data and the twelfth data, are subjected to the butterfly operation.

Thus, at least before starting the third stage, at least one data transfer is performed so that all the data required at the third stage and the real LAST stage (namely, third stage and beyond) may exist on the cache memory 13. Therefore, as will be understood from FIG. 5A, it is necessary that at least before starting the third stage, the zeroth to third data are written (MW) from the cache memory 13 into the external memory 2, and the zeroth, fourth, eighth and twelfth data are read (MR) from the external memory 2, and held in the cache memory 13. Thereby, the data transfer (first data transfer) between the third stage and the real LAST stage may be unnecessary.

Additionally, the above-mentioned second data transfer may be omitted, if possible, in the present invention. That is, the combination of data in the butterfly operation of multiple stages (chiefly operation step d) for the real number FFT operation is also considered. That is, in FIG. 5A and FIG. 5B, at the third stage, the zeroth data and the eighth data, and the fourth data and the twelfth data, are subjected to the butterfly operation, and at the second stage, the zeroth data and the fourth data, and the eighth data and the twelfth data are subjected to the butterfly operation. Others are similarly dealt with.

From this viewpoint, (after the end of the first stage) and before starting the second stage, at least one data transfer is performed so that all the data required at the second stage and beyond may exist on the cache memory 13, as shown in FIG. 5A. That is, before starting the second stage, the zeroth to third data are written (MW) from the cache memory 13 into the external memory 2, and the zeroth, fourth, eighth and twelfth data are read (MR) from the external memory 2, and held in the cache memory 13. Other data (for example, second, sixth, tenth and fourteenth data) are similarly dealt with.

Thereby, the data transfer (second data transfer) between the second stage and the third stage may be unnecessary. That is, the number of making the second data transfer can be the required minimum number. Additionally, the data transfer (first data transfer) between the third stage and the real LAST stage may be unnecessary, as previously described.

Herein, when the size Dc of the cache memory 13 is the amount of four data, the data transfer between the second stage and the third stage can not be unnecessary for eight data of the first, fifth, . . . , eleventh and fifteenth data, as will be seen from FIG. 5A. However, when the size Dc of the cache memory 13 is the amount of eight data, the data transfer between the second stage and the third stage may be unnecessary for those eight data, as will be seen from FIG. 5B.

In this manner, according to the present invention, access to the external memory 2 may be unnecessary in the stage units as many as the power with base 2 for the size Dc of the cache memory 13. That is, according to the present invention, by setting the size Dc of the cache memory 13 to a prescribed value, the number of data transfer in the real number FFT operation may be only one, so that the timing of the data transfer can be decided.

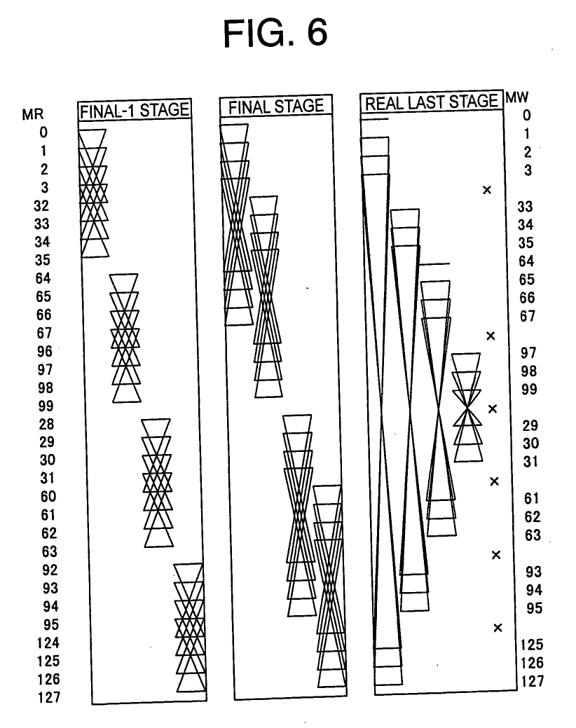

FIG. 6 is an extended example of FIG. 5A and FIG. 5B. That is, this example is the real number FFT with 128 points of input data. The size Dc of the cache memory 13 is the amount of 32 data.

In FIG. 6, for the convenience sake of illustration, the stages corresponding to the second, third and real LAST stage in FIG. 5A or FIG. 5B are only shown. That is, before starting the stage (last-1 stage) corresponding to the second stage, the data transfer is performed according to the present invention. Consequently, the zeroth, first, . . . , 126th and 127th data may exist on the cache memory 13 as shown in FIG. 6. Thereby, the last-1 stage, the last stage (stage corresponding to the third stage) and the real LAST stage can be performed without making the data transfer.

In FIG. 6, 32 data may exist on the cache memory 13 at the same time. The 32 data expanded on the cache memory 13 are given a sequential data number in a unit of 4 data. That is, they may exist at sequential addresses in the external memory 2. The external memory 2 may be DRAM 2, for example. With the burst transfer that is a fast transfer mode of the DRAM 2, the data at 4 addresses can be transferred sequentially. Accordingly, 4 data having the sequential data number can be transferred between the DRAM 2 and the cache memory 13 by one burst transfer in this example. Thereby, the time required for individual data transfer can be shortened and the operation time can be shortened.

That is, according to the present invention, the number of second data transfer may be the required minimum number while keeping the improved access speed by the burst transfer, as far as the number of stage units is within the power with base 2 for (Dc/Db), whereby the first data transfer may be omitted. Where Db is the number of burst transfer data.

In FIG. 6, for the data indicated by “×” sign, the paired data to be operated does not exist on the cache memory 13. That is, the data exists on (is read into) the cache memory 13 in another period, or exists on another cache memory 13. Therefore, the data is saved as the supplementary variable in the variable storage area of the cache memory 13 or another cache memory 13 (see FIG. 1B). Thereby, even in a case the data indicated by “×” sign exists, the real number FFT of the present invention is not affected.

For example, in the example of FIG. 6, since the number of points of input data is 128 and the size of the cache memory 13 is 32 data, the data is divided into four in time division and calculated by one DSP 1. When the first FFT operation in time division is ended, the data indicated by “x” sign is saved in the cache memory 13, and in the second FFT operation in time division the data indicated by “x” sign is employed.

For example, two DSPs 1 may be employed to divide the data into two in time division for performing parallel operations. Or four DSPs 1 may be employed for performing parallel operations. In any case, the data indicated by “×” sign in the first FFT operation is saved in the cache memory 13, and employed in the subsequent other FFT operation.

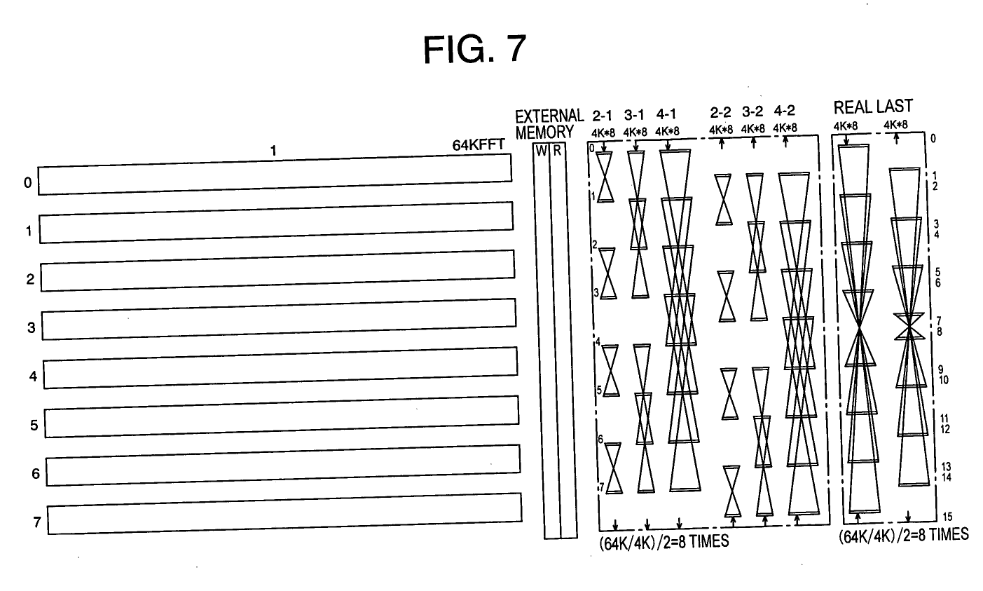

FIG. 7 is a further extended example of FIGS. 5A to 6. That is, this example is the real number FFT for the input data of 1M points (2 to the power of 20). The size Dc of the cache memory 13 is the amount of 64K (kilo) data (65536 data). The number of burst transfer data is 4K data (4096 data).

In FIG. 7, the first stage is performed in the following way. That is, 512K (1M in the real number FFT operation, at operation step b) data is divided into eight groups (zeroth to seventh group) for every 64K (128K) in the order from the top, and one DSP 1 performs the real number FFT operation for those data in time division. The real number FFT operation is performed for each of the zeroth to seventh groups in this order. Since the data of each group is 64K data, it can be stored in the cache memory 13. After execution of the first stage, the data transfer is performed according to the present invention. Thereby, the second to fourth stages and the real LAST stage can be performed without making the data transfer as shown in FIG. 7.

In this example, the FFT operation unit 10 equally divides the butterfly operation after the data transfer into the butterfly operation toward the ascending direction of the data (ascending order of data position or address, same below) and the butterfly operation toward the descending direction of the data (descending order of data position or address, same below). That is, the second stage is divided into the second-1 stage and the second-2 stage. The second-1 stage is the butterfly operation toward the ascending direction of data (or from the top of data), and involves the operation of 32K data. The second-2 stage is the butterfly operation toward the descending direction of data (or from the last of data), and involves the operation of 32K data. Accordingly, the second-1 stage and the second-2 stage can be performed using the data on the cache memory 13. The third and fourth stages are similarly performed. The data position is predetermined as well known.

At first, the first 32K data (64K in total) at the second-1 stage and the second-2 stage are read from the external memory 2 into the cache memory 13. Each 32K data is burst transferred for every 4K data.

As will be seen from FIG. 7, the first 32K data at the second-1 stage comprises eight groups of data for every 4K data placed sporadically in the ascending direction of address. The first 32K data at the second-2 stage comprises eight groups of data for every 4K data placed sporadically in the descending direction of address. And the first 32K data at the third-1 stage and the fourth-1 stage are calculated directly employing the first 32K data at the second-1 stage. In other words, according to the present invention, the first 32K data is read sporadically so that such sequential butterfly operations may be permitted. The second-2 stage to the fourth-2 stage are similarly performed. Accordingly, the data transfer is unnecessary in these periods.

As will be further seen from FIG. 7, the first 64K data at the real LAST stage can be calculated directly employing the first 32K data (64K data in total) at both the fourth-1 stage and the fourth-2 stage. The 64K data in total (128K data for the real number FFT operation) thus obtained is memory written from the cache memory 13 into the external memory 2.

Thereafter, the data transfer (third data transfer) for time division processing is performed to read 32K data following the first 32K data into the cache memory 13. Likewise, the operation from the second stage to the real LAST stage can be performed without making the data transfer.

As described above, in this example, the data transfer between the cache memory 13 and the external memory 2 is performed once per size Dc of the cache memory 13. That is, since the number of second data transfer is the required minimum number as far as the number of stage units is within the power with base 2 for (Dc/Db), as previously described, the data transfer is only once performed. The first data transfer is omitted.

Accordingly, in this example, access to the external memory may be performed only once in the middle of the FFT butterfly operation. Also, since access to the external memory is made by burst transfer at high speed, the high-speed FFT operation can be performed. Thereby, the time of butterfly operation is roughly halved, and in the operation after shuffling, access to the external memory 2 is omitted at almost all the stages of the butterfly operation and the real LAST stage. As a result, in this example, the time required for the butterfly operation before shuffling is about 1.8 milliseconds in total, the time required for the memory write and memory read for shuffling is about 1 millisecond×2 in total, and the time required for the operation after shuffling is about 0.34 milliseconds in total (all including the third data transfer time). The operation clock of the DSP 1 is 1 GHz. In this manner, since the percentage of memory access time occupied over the total operation time is large, there is the significant effect because the memory access after shuffling is omitted according to the present invention.

As described above, in the FFT operation apparatus and method according to the present invention, the number of real number FFT operation can be half the number of normal FFT operation, whereby it is unnecessary to perform the data transfer immediately before the operation for restoring the transform results from the results of the real number FFT operation. Accordingly, with the present invention, the time of FFT operation itself can be shortened, and the time of data transfer can be shortened, whereby the FFT operation for an extremely large amount of data can be performed in real time.

Thereby, the FFT operation for an extremely large amount of data outputted from a large electric wave interferometer can be performed in real time, using one or more DSPs available on the market, without using the supercomputer.

Moreover, since the enormous FFT operation can be performed in real time by the DSPs available on the market, a lot of signal processings for the electric wave interferometer or others can be simply performed only by mounting the DSPs on the personal computer, for example.

Also, since the FFT operation is the basis of many scientific and technical computations, various scientific and technical computations including the FFT operation can be performed in real time by using the DSPs available on the market, without using the supercomputer.

What is claimed is:

1. An FFT operation apparatus comprising:
an external memory for storing data to be subjected to the real number FFT operation;
a cache memory for storing a part of the data to be subjected to the real number FFT operation by performing the data transfer with the external memory, the size of the cache memory being smaller than the size of the data to be subjected to the real number FFT operation; and
an FFT operation unit for performing the real number FFT operation for the data stored in the cache memory, the real number FFT operation comprising first butterfly operation of multiple stages and second butterfly operation for acquiring the transform results,
wherein the FFT operation unit performs the data transfer between the cache memory and the external memory at least once after any of the stages in the first butterfly operation of multiple stages to read data to be required in subsequent butterfly operation in the first butterfly operation of multiple stages and the second butterfly operation for acquiring the transform results into the cache memory, performs the subsequent butterfly operation in the first butterfly operation of multiple stages using the read data, and performs the second butterfly operation for acquiring the transform results directly using the data stored in the cache memory after the first butterfly operation of multiple stages.

2. The FFT operation apparatus according to claim 1, wherein the FFT operation unit performs the data transfer between the cache memory and the external memory only in a fast transfer mode which is provided in the external memory.

3. The FFT operation apparatus according to claim 1, wherein the FFT operation unit performs the butterfly operation after the data transfer by dividing the butterfly operation into the butterfly operation toward the ascending order of data to be subjected to the real number FFT operation and the butterfly operation toward the descending order of data to be subjected to the real number FFT operation.

4. The FFT operation apparatus according to claim 1, wherein the FFT operation unit performs the real number FFT operation in time division for the data to be subjected to the real number FFT operation.

5. The FFT operation apparatus according to claim 1, further comprising:
a plurality of the FFT operation units,
wherein the plurality of the FFT operation units perform the real number FFT operation in parallel for the data to be subjected to the real number FFT operation.

6. An FFT operation apparatus comprising:
an external memory for storing data to be subjected to the real number FFT operation;
a cache memory for storing a part of the data to be subjected to the real number FFT operation by performing the data transfer with the external memory, the size of the cache memory being smaller than the size of the data to be subjected to the real number FFT operation; and
an FFT operation unit for performing the real number FFT operation for the data stored in the cache memory, the real number FFT operation comprising first butterfly operation of multiple stages and second butterfly operation for acquiring the transform results,
wherein the FFT operation unit performs the data transfer between the cache memory and the external memory only once per size of the cache memory after any of the stages in the first butterfly operation of multiple stages to read data to be required in subsequent butterfly operation in the first butterfly operation of multiple stages and the second butterfly operation for acquiring the transform results into the cache memory, and performs the subsequent butterfly operation in the first butterfly operation of multiple stages and the second butterfly operation for acquiring the transform results directly using the data stored in the cache memory.

7. The FFT operation apparatus according to claim 6, wherein the FFT operation unit performs the data transfer between the cache memory and the external memory only in a fast transfer mode which is provided in the external memory.

8. The FFT operation apparatus according to claim 6, wherein the FFT operation unit performs the butterfly operation after the data transfer by dividing the butterfly operation into the butterfly operation toward the ascending order of data to be subjected to the real number FFT operation and the butterfly operation toward the descending order of data to be subjected to the real number FFT operation.

9. The FFT operation apparatus according to claim 6, wherein the FFT operation unit performs the real number FFT operation in time division for the data to be subjected to the real number FFT operation.

10. The FFT operation apparatus according to claim 6, further comprising:
a plurality of the FFT operation units,
wherein the plurality of the FFT operation units perform the real number FFT operation in parallel for the data to be subjected to the real number FFT operation.

11. An FFT operation method for performing the real number FFT operation for the data stored in a cache memory, the operation comprising first butterfly operation of multiple stages and second butterfly operation for acquiring the transform results and using an external memory for storing data to be subjected to the real number FFT operation and the cache memory for storing a part of the data to be subjected to the real number FFT operation by performing the data transfer with the external memory, the size of the cache memory being smaller than the size of the data to be subjected to the real number FFT operation, the method comprising:
performing the data transfer between the cache memory and the external memory at least once after any of the stages in the first butterfly operation of multiple stages to read data to be required in subsequent butterfly operation in the first butterfly operation of multiple stages and the second butterfly operation for acquiring the transform results into the cache memory;
performing the subsequent butterfly operation in the first butterfly operation of multiple stages using the read data; and
performing the second butterfly operation for acquiring the transform results directly using the data stored in the cache memory after the first butterfly operation of multiple stages.

12. An FFT operation method for performing the real number FFT operation for the data stored in a cache memory, the operation comprising a butterfly operation of multiple stages and a butterfly operation for acquiring the transform results and using an external memory for storing data to be subjected to the real number FFT operation and the cache memory for storing a part of the data to be subjected to the real number FFT operation by performing the data transfer with the external memory, the size of the cache memory being smaller than the size of the data to be subjected to the real number FFT operation, the method comprising:
changing sequence of data on the cache memory halfway of the first butterfly operation of multiple stages to make unnecessary the data transfer between the cache memory and the external memory in the middle of the first butterfly operation of multiple stages and the second butterfly operation for acquiring the transform results.
